(19) United States
(12) Patent Application Publication
(10) Pub. No.: US 2006/0170646 A1
(43) Pub. Date: Aug. 3, 2006

(54) Drive device of display panel

(75) Inventors: Chin-Wen Chou, Hsin-Tien City (TW); Ying-Nan Cheng, Hsin-Tien City (TW); Kuang-Ming Wu, Hsin-Tien City (TW)

Correspondence Address: BIRCH STEWART KOLASCH & BIRCH, PO BOX 747, FALLS CHURCH, VA, 22040-0747, US

(73) Assignee: Zippy Technology Corp.

(21) Appl. No.: 11/048,708

(22) Filed: Feb. 3, 2005

(51) Int. Cl. G09G 3/36

(52) U.S. Cl. 345/102

(57) ABSTRACT

The present invention relates to a drive device of display panel, which integrates the drive circuit of the display panel and the drive circuit of the backlight module to enable the image-display timing of the display panel to mate the light-dark timing of the luminance variation cycle of the backlight module so that the picture quality of the display panel can be promoted.

### FIELD OF THE INVENTION

The present invention relates to a drive device of display panel, particularly to a drive device, which applies to a display panel with backlight illumination and promotes the picture quality thereof.

### BACKGROUND OF THE INVENTION

The liquid crystal display (LCD) panel, which utilizes the twist of liquid crystal molecules to display images, has become prevailing, and the quality of dynamic images becomes the determining factor when the consumer selects LCD panels with the audio/video function.

When the current LCD panel performs image display, the color displayed by the current LCD panel is usually found not true enough. It primarily results from the influences of contrast level and response time. The response time herein refers to the span of time that a liquid crystal cell spends shifting from light to dark and then back to light, i.e. the time that a pixel spends shifting from white to black and then back to white. The response time is of the order of millisecond (ms), and the longer the response time, the slower the panel's reaction, which is directly related to the image output, for example, a display panel with 20 ms of response time can represent fifty (1/0.020) pictures that shift from dark to light, which amount to one hundred pictures equivalently. The contrast level mentioned above refers to the ratio of the brightness of the brightest point to that of the darkest point, and the higher the contrast level, the more the gradient layers; in fact, this figure indicates the number of the gray levels that the display panel can represent.

In the conventional technology, the twist time of liquid crystal cell is larger than the response time of display panel; thus, when the display panel has changed the picture, the prior picture cannot renew in time; consequently, the trailing or residual image effects will appear, which influence the picture quality. However, if the response time increases, the picture will be delayed, which is especially apt to happen when the consumer plays the motion-picture game or watches the movies.

### SUMMARY OF THE INVENTION

The primary objective of the present invention is to integrate the drive circuit of display panel and the drive circuit of backlight module to enable the image-display timing to mate the light-dark timing of the luminance variation so that the picture quality of the display panel can be promoted.

### BRIEF DESCRIPTION OF DRAWINGS

FIG. 1 is a schematic function block diagram of the present invention.

FIG. 2 is a schematic diagram showing the drive power of the backlight module of the present invention.

FIG. 3 is a schematic diagram showing the luminance variation cycle of the backlight module of the present invention.

### DETAILED DESCRIPTION OF THE PREFERRED EMBODIMENTS

In cooperation with the attached drawings, the detailed description and the technical contents of the present invention are stated below.

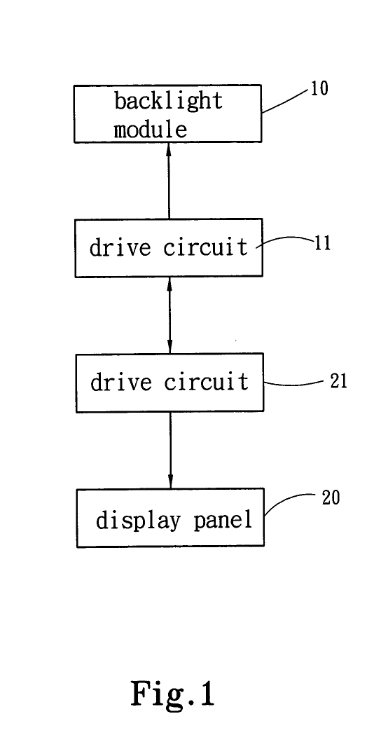

Please refer to FIG. 1, a schematic function block diagram of the present invention as shown in FIG. 1, the present invention's drive device of display panel 20 comprises: a backlight module 10 and a drive circuit 11 of the backlight module 10, which are used to control the backlight source of the display panel 20, wherein the drive circuit 11 of the backlight module 10 has a means of creating a luminance variation cycle T to enable the backlight module 10 to represent light-dark timings t1 and t2 of luminance; and the display panel 20 and a drive circuit 21 of the display panel 20, which are used to control the image shift of the display panel 20, wherein the drive circuit 21 of the display panel 20 has a means of creating an image-display timing corresponding with the luminance variation cycle T to enable the image-display timing to mate the light-dark timings to and t2 of the luminance of the backlight module 10 so that the picture quality of the display panel 20 can be promoted.

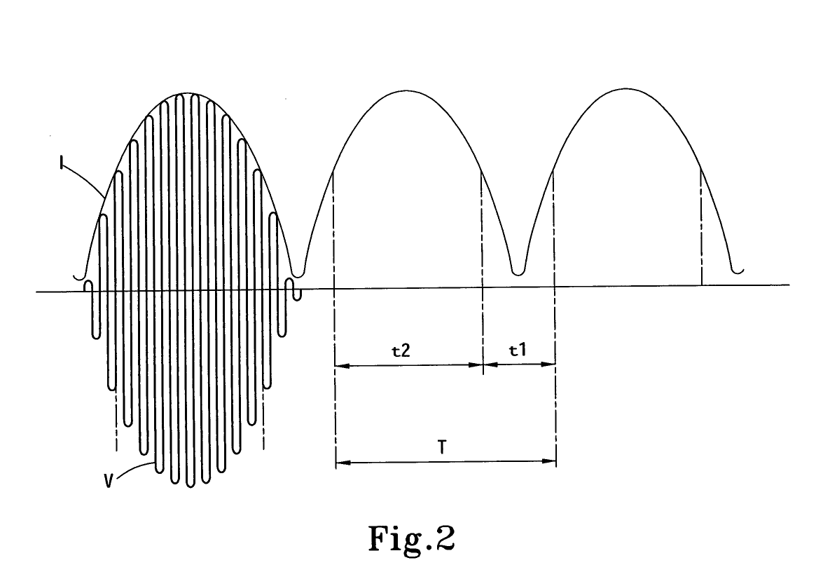

Please refer to FIG. 2 as well. The aforementioned means of creating the luminance variation cycle T, which is achieved via the drive circuit 11 of the backlight module 10, comprises: an inverter, which outputs a variable voltage V, and a lamp set, which is driven by the variable voltage V and creates a luminance variation according to the value of the variable voltage V, wherein the lamp set can be a planar lamp or cold cathode fluorescent lamps (CCFL) and the inverter can be a piezoelectric-type inverter or a coil-type one. This embodiment of the present invention is to be exemplified with the waveform of the drive power output by the piezoelectric-type inverter as shown in FIG. 2, the drive voltage output by the inverter is a variable voltage V, and the drive current is a variable current I, and thus, the lamp set, which is driven by the variable voltage V, creates a variable luminance, wherein the timing can be divided into bright t2 and dark t1 according to the luminance that illuminates the display panel 20 to display images. As the drive voltage is relatively low in the timing t1, the lamp set is dim and in a light-invisible state; contrarily, in the timing t2, the lamp set is in a light-visible state. The drive circuit 21 of the display panel 20 will obtain the signal of the luminance variation cycle T and arrange the image-display timing according to the light-dark timings t1 and t2 of the luminance of the backlight module 10. The means of creating image-display timing can be achieved via an arrayed scanning lines' method. Thus, the objective of promoting the picture quality of the display panel 20 can be accomplished.

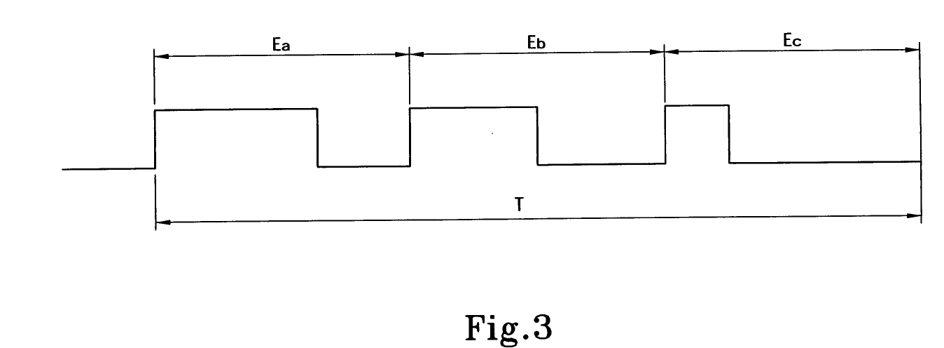

Refer to FIG. 3. The difference in contrast with FIG. 2n is the means of creating the luminance variation cycle T, which is achieved via the drive circuit 11 of the backlight module 10, comprises: an inverter, which outputs the drive voltage; a light-modulating circuit, which outputs an energy/timing-modulating signal to control the drive voltage; and a lamp set, which is driven by the drive voltage to create luminance variation. In this embodiment, the luminance variation cycle T is achieved via the light-modulating circuit. The luminance variation cycle T as shown in FIG. 3 includes multiple light source signals of time-varying integrated energy Ea, Eb, and Ec, wherein Ea>Eb>Ec. (For the detailed technical contents of time-varying integrated energy Ea, Eb, and Ec, refers to the issued U.S. Pat. No. 6,839,253 applied by the current applicant). Thus, within the cycle T of the luminance variation, the lamp set will represent the light-dark timings t1 and t2. The drive circuit 21 of the display panel 20 will also obtain the signal of the luminance variation cycle T and arrange the image-display timing according to the light-dark timings t1 and t2 of the luminance of the backlight module 10. Thus, the objective of promoting the picture quality of the display panel 20 can be accomplished.

Those described above are only the preferred embodiments of the present invention and not intended to limit the scope of the present invention, and any equivalent modification and variation according to the claims of the present invention is to be included within the scope of the present invention.

What is claimed is:

1. A drive device of display panel, comprising:
a backlight module and a drive circuit of said backlight module, which are used to control the backlight source of said display panel, wherein said drive circuit of said backlight module has a means of creating a luminance variation cycle to enable said backlight module to represent a light-dark timing of luminance; said display panel and said drive circuit of said display panel, which are used to control the image shift of said display panel, wherein said drive circuit of said display panel has a means of creating an image-display timing corresponding with said luminance variation cycle to enable said image-display timing to mate said light-dark timing of luminance so that the picture quality of said display panel can be promoted.

2. The drive device of display panel according to claim 1, wherein said means of creating said luminance variation cycle, which is achieved via said drive circuit of said backlight module, comprises: an inverter, which outputs a variable voltage; and a lamp set, which is driven by said variable voltage and creates a luminance variation according to the values of said variable voltage.

3. The drive device of display panel according to claim 1, wherein said means of creating said luminance variation cycle, which is achieved via said drive circuit of said backlight module, comprises: an inverter, which outputs a drive voltage; a light-modulating circuit, which outputs an energy/timing-modulating signal to control said drive voltage; and a lamp set, which is driven by said drive voltage to create a luminance variation.

4. The drive device of display panel according to claim 1, wherein said means of creating said image-display timing is achieved via an arrayed scanning lines' method.
